(19) United States
(12) Patent Application Publication
(10) Pub. No.: US 2006/0021940 A1
(43) Pub. Date: Feb. 2, 2006

(54) Method and device for integrated analysis of a hydrocarbon sample

(76) Inventors: Fabrice Bertoncini, Lyon (FR); Veronique Lachet, Meudon La Foret (FR); Jean-Jacques Beboulene, Croissy-sur-Seine (FR); Christophe Fejean, Yerres (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/194,531

(22) Filed: Aug. 2, 2005

(30) Foreign Application Priority Data
Aug. 2, 2004 (FR) 04/08.518

(51) Int. Cl. B01D 15/08

(52) U.S. Cl. 210/656

(57) ABSTRACT

a) The invention relates to an integrated analysis method and device for characterization of a hydrocarbon sample in distillation fractions. The method carries out a simulated distillation so as to separate the sample into a light fraction and at least one heavy fraction, analyzes the light fraction, collects at least one heavy fraction after separation, and analyzes in detail at least one heavy fraction.

### BACKGROUND OF THE INVENTION

1. Field of the Invention

The present invention relates to the technical sphere of hydrocarbon sample analysis. More particularly, the invention relates to an integrated device allowing analysis of a variety of hydrocarbons with a variable number of carbon atoms, which previously usually required using several devices.

2. Description of the Prior Art

French Patent 2,787,576 describes an integrated analysis method for characterization of a hydrocarbon sample in distillation fractions comprising simulated distillation by gas chromatography in two interconnected columns, so as to separate the sample into at least a first light fraction and at least another heavy fraction, collecting the fractions on retention means, analyzing in detail each light fraction, on the one hand, and each heavy fraction, on the other hand, by connecting up the corresponding retention means respectively to at least one gas chromatography set and to a combined liquid and gas chromatography set.

The method described in the above-referenced French patent involves a implementation complexity, in particular because of the systematic use of retention means, even for the lighter gas fractions.

### DETAILED DESCRIPTION

The present invention thus relates to an integrated analysis method for characterization of a hydrocarbon sample in distillation fractions, comprising:
a) carrying out a simulated distillation in at least one gas chromatography column so as to separate the sample into a light fraction and at least one heavy fraction;
b) analysing in detail the light fraction by connecting the gas chromatography column of step a) to an analysis means suited for analysis of the light fraction and by carrying said fraction into said analysis means;
c) collecting at least one heavy fraction after separation, by connecting the gas chromatography column of step a) to a retention means and by carrying said fraction into said retention means; and
d) analyzing in detail at least one heavy fraction by connecting a retention means to an analysis means suited for analysis of the heavy fraction and by carrying said fraction into said analysis means.

The invention is an integrated analysis method and device allowing the aforementioned drawbacks to be overcome.

The method according to the invention allows integrated analysis for characterization of a hydrocarbon sample. What is understood to be a hydrocarbon sample is generally a petroleum product such as, for example, reservoir fluids or refining process effluents.

The sample is generally introduced in full in the method of the invention, that is without previous fractionation.

The method according to the invention can be advantageously used for analysis of a hydrocarbon sample that can comprise hydrocarbons having 1 to 40 carbon atoms.

Analysis of the sample according to the invention is carried out by distillation fraction. It is therefore not necessary to perform fractionated distillation.

During step a) of the method according to the invention, a simulated distillation is carried out in at least one gas chromatography column so as to separate the sample in a light fraction and at least one heavy fraction.

Simulated distillation means that the sample is separated by gas chromatography on a capillary chromatography column under temperature programming, that is using the temperature in said column to recover, at the column outlet, fractions having a given molecular weight or, more precisely, a given molecular weight range.

More precisely, simulated distillation is obtained by separating the sample comprising a mixture of hydrocarbons, by gas chromatography, under suitable temperature programming conditions, of stationary and mobile phases. This separation is performed in such a way that there is a relation between the retention time and the boiling-point temperature of a species, the retention being then mainly governed by the volatility of the species. It is thus possible to relate the eluted fraction of the sample to a boiling temperature and to obtain, by extrapolation, a “simulated” distillation curve.

Thus, the temperature of the capillary chromatography column can be raised to allow to separate first the light fraction and then at least one heavy fraction, which generally has longer elution times in the chromatography column and a higher boiling temperature. Thus, simulated distillation according to the invention allows obtaining the same result as with fractionated distillation.

One advantage of simulated distillation according to the invention in relation to fractionated distillation is that this technique is compatible with a very small sample proportion. This sample proportion can be of the order of 10⁻⁶ litres to obtain fractionation into 2, 3 or 4 fractions.

Another advantage of simulated distillation according to the invention in relation to fractionated distillation is that the fractions obtained are directly analyzed, possibly after being recovered through the agency of an in-line retention means, that is in a continuous manner.

The gas chromatography column used in step a) of the method according to the invention can be any column known to those people skilled in the art. The gas chromatography column is generally a capillary column whose inside diameter can range from 0.2 to 1 mm, preferably from 0.32 to 0.53 mm, for example 0.53 mm.

The gas chromatography column of step a) can advantageously include a stationary phase film. The stationary phase can be made of any material known to the person skilled in the art such as, for example, a “grafted polysiloxane” type polymer. Preferably, the stationary phase is made of a non-polar material such as, for example, polydimethylsiloxane. The length and the thickness of the film can be optimized to ensure elution of paraffins having at least 40 carbon atoms, and to maintain a chromatographic resolution, between the hydrocarbons having 5 carbon atoms and those having 6 carbon atoms, above 3. This resolution level allows ensuring efficient separation of the light fractions and of the heavy fractions as defined hereafter.

The light fraction obtained in stage a) is generally obtained first at the chromatography column outlet. This fraction can comprise the lighter hydrocarbons. Preferably, the light fraction comprises at least 90% by weight of compounds having 1 to 5 carbon atoms.

The or each heavy fraction obtained in step a) is generally obtained after the light fraction. The or each heavy fraction can comprise at least 90% by weight of hydrocarbons boiling above 35° C. Preferably, the or each heavy fraction can comprise at least 90% by weight of hydrocarbons boiling above 35° C., preferably above 40° C.

Separation of the light fraction and of the heavy fraction(s), as well as injection of the sample, are generally carried out by means of a carrier gas. This carrier gas can be helium. The carrier gas flow rate can be determined by the person skilled in the art, according to the diameter of the chromatography column of step a) and to the amount of sample injected. For example, implementation of a capillary column 0.53 mm in inside diameter can require a flow rate of 2 ml carrier gas per minute.

According to a particular case of the invention, step a) of the method according to the invention uses a chromatography precolumn arranged upstream from the column used for simulated distillation and laid out so as to recover certain very heavy fractions by backflushing. This precolumn can be used to recover a very heavy fraction comprising, for example, at least 90% by weight of hydrocarbons having at least 30, preferably at least 40 carbon atoms.

During step b) of the method according to the invention, the light fraction is analyzed in detail by connecting the gas chromatography column of step a) to an analysis means suited for analysis of the light fraction and by carrying the fraction in said analysis means.

Preferably, the analysis means suited for analysis of the light fraction comprises a katharometric detector.

Preferably, prior to light fraction analysis, the fraction is sent to a chromatography column allowing the resolution of the separation of the light fraction constituents to be improved. It can be a column filled with any material known to the person skilled in the art such as, for example, a polydivinylbenzene type adsorbent polymer, of inside diameter 0.53 mm and of length of at least 10 m.

Carrying the light fraction to the analysis means is generally provided by the entrainment due to the flow of the carrier gas used to inject the sample and to separate the light fraction and the heavy fraction(s) of said sample.

During step c) of the method according to the invention, at least one heavy fraction is collected after separation, by connecting the gas chromatography column of step a) to a retention means and by carrying said fraction into said retention means.

Connecting the chromatography column of step a) to the retention means is generally understood to be an action allowing to connect the outlet of the column, that is the end of the column through which the eluted compounds of the sample are recovered by simulated distillation, to the retention means. In this case, carrying the heavy fraction in the retention means is generally provided by the same carrier gas used to inject the sample and to separate the light fraction and the heavy fraction(s) of said sample.

In the particular case where step a) comprises using a chromatography precolumn, a very heavy fraction is collected or directly analysed in step c) by connecting the gas chromatography column to a retention means or directly with an analysis means and by carrying the fraction in the retention or analysis means. Connecting the precolumn to the retention or analysis means is generally achieved by connecting the precolumn inlet, that is the end of the precolumn through which the sample is introduced, to the retention or analysis means. Carrying the very heavy fraction in the retention or analysis means is generally performed by backflushing through injection of a carrier gas at the precolumn outlet to obtain flushing in this precolumn in the opposite direction to the direction of elution of the sample compounds.

If several heavy fractions are separated, these heavy fractions can be recovered on separate retention means or on a single retention means during separate time intervals.

The or each retention means used in step c) can be any means known to the person skilled in the art allowing a heavy fraction as defined above to be retained. It can be, for example, a cryogenic trapping means operating at a temperature that can range from −200° C. to −20° C. If the retention means is a cryogenic trapping means, this means comprises specific dimensions. The cryogenic retention means can comprise a stainless steel capillary tube connected to the outlet of the simulated distillation column arranged in an enclosure operating in the aforementioned temperature range. This tube can thus collect the fraction to be trapped through local temperature decrease.

In general, the or each retention means can comprise a capillary tube wherein the heavy fraction compounds are trapped by the temperature decrease. The diameter of the capillary tube can range from 0.5 to 50 mm, preferably from 1 to 10 mm, for example 7 mm. This capillary tube can be brought to a temperature ranging from −200° C. to 400° C., preferably from −200° C. to 300° C., for example 100° C. Such temperatures can be reached through the agency of any means known to the person skilled in the art such as, for example, enclosures having suitable volumes in relation to the dimensions selected for the trap, which can be continuously flushed with a liquid nitrogen stream, having an evaporation temperature of about −200° C., and provided with flowmeters allowing regulation of the liquid nitrogen flow so as to adjust the local temperature in the vicinity of the trap to the desired temperature.

During step d) of the method according to the invention, at least one heavy fraction is anaylzed in detail by connecting a retention means of step c) to an analysis means suited for analysis of the heavy fraction and by carrying said fraction into said analysis means.

The means dedicated to analysis of a heavy fraction can be a katharometric detector, a flame ionization detector FID or a combined liquid and gas chromatography set. The analysis means suited for analysis of a heavy fraction can also comprise a gas chromatography column arranged upstream therefrom and allowing the analysis resolution to be improved.

Preferably, carrying the or of each heavy fraction between the retention means and the analysis means can comprise a desorption of said fraction contained in said retention means, followed by flushing by means of a liquid or gaseous carrier fluid between the retention means and the analysis means.

Desorption of the heavy fraction can be achieved by any means known to the person skilled in the art such as, for example, by heating. The heating temperature can range from 100 to 400° C., preferably from 200 to 300° C. for a heavy fraction containing mainly compounds with 5 to 15 carbon atoms.

Preferably, carrying the or each heavy fraction between the retention means and the analysis means comprises a stage of isolation of the retention means, a stage of desorption by heating the retention means, and a flushing stage using a liquid or gaseous carrier fluid between the retention means and the corresponding analysis means.

During the isolation step, the retention means can be isolated by actuating a set of valves, multiway valves for example, in order to disconnect the retention means considered. The fraction to be trapped is thus retained in the retention means and the next fractions are redirected towards other retention and/or analysis means by actuating the set of valves.

During the heating stage, the isolated retention means is heated in order to provide change of the trapped fraction from the solid state to the liquid or gaseous state.

During the flushing stage, the set of valves is actuated so as to connect again the retention means, which is then flushed with a carrier gas carrying along the previously trapped fraction.

According to a particular mode of the method according to the invention:
during step a), a light fraction, a first heavy fraction and a second fraction heavier than the first one are separated by simulated distillation,
during step c), the first and the second heavy fractions are collected successively, after each separation of the fractions, by connection of the gas chromatography column to respectively a first and a second retention means and by carrying the heavy fractions into their respective retention means, and
during step d), the first and the second heavy fractions are analyzed in detail by connection of the first and second retention means to respectively a flame ionization detector FID and a combined liquid and gas chromatography set, and by carrying the first and second heavy fractions into respectively the flame ionization detector FID and the combined liquid and gas chromatography set.

In this particular mode of the invention, the first and second heavy fractions of the sample are separated by elution at the outlet of the chromatography column. The heavy fractions are eluted at the chromatography column outlet after the light fraction because the retention times of said heavy fractions are longer than the retention time of the light fraction.

Preferably, in this particular mode, the first heavy fraction can comprise 90% by weight of compounds having between 5 and 15 carbon atoms.

Preferably, in this particular mode, the second heavy fraction can comprise 90% by weight of compounds having more than 15 carbon atoms.

In the particular case where, during step a) of the method according to the invention, a chromatography precolumn arranged upstream from the column used for simulated distillation and laid out so as to recover certain heavy fractions by backflushing is used, the distillation fractions can comprise an additional very heavy fraction. This very heavy fraction can comprise 90% by weight of compounds having more than 30 carbon atoms. This very heavy fraction is generally recovered by backflushing of the precolumn.

The present invention also relates to an integrated analysis device for characterization of a hydrocarbon sample in distillation fractions, characterized in that it comprises:
a sample injection means;
a gas chromatography column laid out so as to perform, by simulated distillation, separation of the sample into a light fraction and at least one heavy fraction;
an analysis means suited for analysis of the light fraction;
at least one retention means for collecting the or each heavy fraction after separation;
at least one analysis means suited for analysis of the or each heavy fraction;
connection means for connecting up the injection means, the chromatography column, the analysis means suited for analysis of the light fraction, the retention means and the analysis means suited for analysis of each heavy fraction; and
means for carrying the light fraction and the heavy fractions between the chromatography column, the retention means and the analysis means.

More precisely, the means for connecting up the device according to the invention can allow connection of the gas chromatography column to the analysis means suited for analysis of the light fraction, of the gas chromatography column to each retention means and of each retention means to each analysis means suited for analysis of the corresponding heavy fraction.

Preferably, the connection means are operated so as to successively:
connect the gas chromatography column for simulated distillation to the analysis means suited for analysis of the light fraction when the light fraction is eluted by said column;
connect the gas chromatography column for simulated distillation to the retention means corresponding to the or each heavy fraction eluted by said column; and
connect the heavy fraction retention means to the analysis means suited for analysis of the or each corresponding heavy fraction.

According to a preferred mode, the gas chromatography column for simulated distillation is equipped with a katharometric detector suited for real-time determination of the nature of the fraction discharged from said column. According to a more preferred mode, the katharometric detector is mounted so as to control the device connection means according to the nature of said fraction discharged from said column.

The connection means can be any means known to the person skilled in the art, for example multiway electropneumatic valves connected by 300° C.-traced lines, more preferably 4-way valves.

The connection means can be synchronized valves in a high-temperature heating block or provided with traced lines.

The light fraction carrying means preferably comprise a flushing means for a carrier gas between the chromatography column and the means intended for analysis of said fraction. This carrier gas flushing means can advantageously correspond to the means used in the sample injection means.

The heavy fraction carrying means preferably comprise at least one flushing means for a gaseous or liquid carrier fluid between the chromatography column and a retention means, on the one hand, and between the retention means and an analysis means on the other hand.

For the heavier fractions, typically fractions comprising at least 90% by weight of compounds having more than 15 carbon atoms, the carrier fluid can be liquid, for example n-heptane or iso-heptane.

### BRIEF DESCRIPTION OF THE DRAWINGS

FIG. 1 illustrates a configuration corresponding to a stage of analysis of the C5− light fraction.

FIG. 2 illustrates a configuration corresponding to a stage of trapping the C5-C15 heavy fraction.

FIG. 3 illustrates a configuration corresponding to a stage of trapping the C15+ heavy fraction.

FIG. 4 illustrates a configuration corresponding to a stage of analysis of the C5-C15 heavy fraction.

FIG. 5 illustrates a configuration corresponding to a stage of analysis of the C15+ heavy fraction.

### DETAILED DESCRIPTION OF THE INVENTION

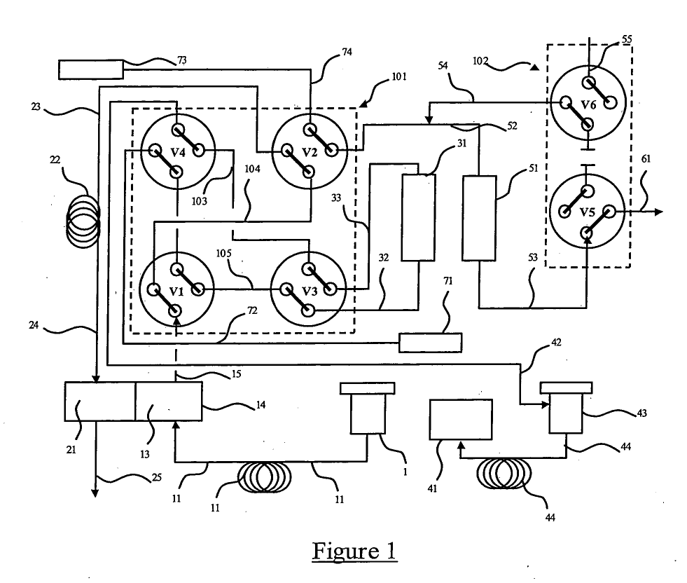

For better comprehension, an embodiment of the device according to the invention is illustrated in FIGS. 1 to 5. This embodiment is given by way of example and has no limitative character. These illustrations of the device according to the invention do not comprise all of the components required for its implementation. Only the elements necessary for comprehension of the invention are shown, the person skilled in the art being able to complete this representation to implement the invention.

The embodiment shown in FIGS. 1 to 5 allows the following three distillation fractions to be treated separately:
a light fraction, C5−, of which 90% by weight of the compounds comprise less than 5 carbon atoms,
a heavy fraction, C5-C15, of which 90% by weight of the compounds comprise between 5 and less than 15 carbon atoms, and
a heavy fraction, C15+, of which 90% by weight of the compounds comprise at least 15 carbon atoms.

Each one of FIGS. 1 to 5 illustrates the implementation of a particular step of the method according to the invention by means of a given configuration of the connection means. The steps of the method shown in FIGS. 1 to 5 can be carried out independently of one another, possibly with overlap periods.

The embodiment of the device shown in FIGS. 1 to 5 is equipped with an injection system 1 allowing introduction of the complete hydrocarbon sample. The injection system comprises a means for introducing on the one hand the sample and, on the other hand, a carrier gas, so as to carry the sample by means of the driving force of the carrier gas. This sample carrying is achieved in column 11 directly brought into contact with the injector.

The sample is subjected to a simulated distillation in chromatography column 11. Distillation fractions are thus produced and carried by means of column 11 to a way 13 of a katharometric detector 14 allowing analysis of the fractions by thermal conductivity. The distillation fractions are then discharged to the analysis means or, if need be, to the retention means through a line 15.

The device shown comprises an analysis means suited for analysis of the C5− light fraction, which consists in the present case of another way 21 of katharometric detector 14. Connecting means 101 described in the description hereafter allow the C5− light fraction to be directed towards way 21 of detector 14. The light fraction thus directed is first passed in a chromatography column 22 by means of a line 23, prior to being carried into way 21 of detector 14 by means of a line 24. The light fraction is then discharged through a line 25.

The device shown comprises a retention means 31 for collecting the C5-C15 heavy fraction. This retention means 31 comprises means, not shown, allowing to focus, to trap and to concentrate the heavy fraction in a stainless steel capillary tube. This retention means 31 also comprises means, not shown, allowing the C5-C15 fraction to be vaporized, for example by heating to a sufficient temperature, 200° C. for example. Connecting means 101 described hereafter allow, on the one hand, the C5-C15 heavy fraction to be directed towards retention means 31 by means of a line 32 and, on the other hand, said fraction to be discharged through a line 33.

The device shown also comprises at least one analysis means suited for analysis of the C5-C15 heavy fraction, in the present case a flame ionization detector 41. Connecting means 101 described hereafter allow the C5-C15 heavy fraction to be directed towards this detector. The C5-C15 fraction thus directed is fed, by means of a line 42, into a dividing injector 43 prior to being sent to chromatography column 44 directly brought into contact with injector 43. The C5-C15 heavy fraction is then sent, after separation, to detector 41.

The device shown comprises a retention means 51 for collecting the C15+ heavy fraction. This retention means 51 comprises means, not shown, allowing to focus, to trap and to concentrate the heavy fraction in a stainless steel capillary tube. This retention means 51 also comprises means, not shown, allowing percolation and solubilization of the C15+ fraction by a liquid carrier fluid. Connecting means 101 and 102 described hereafter allow, on the one hand, the C15+ heavy fraction to be directed towards retention means 51 through a line 52 and, on the other hand, the fraction to be discharged by elution through a line 53 after percolation with the liquid carrier fluid.

The device shown comprises at least one analysis means suited for analysis of the C15+ heavy fraction, in the present case an analyzer LC-GC comprising gas chromatography analysis means coupled with liquid chromatography analysis means, this analyzer is not shown. Connecting means 101 and 102 described hereafter allow the C15+ heavy fraction to be directed towards this analyzer. The C15+ fraction thus directed is sent, through a line 61, to analyzer LC-GC.

The embodiment shown also comprises an oven, not shown, in which columns 11, 44 and 22, as well as detectors 14 and 41 and injectors 1 and 43 are arranged.

The device shown in FIGS. 1 to 5 comprises connecting means 101 and 102 between the chromatography column, the analysis means suited for analysis of the light fraction, the C5-C15 and C15+ heavy fractions retention means and the analysis means suited for analysis of each one of these heavy fractions. These connecting means include six four-way valves, V1 to V6, electrically controlled according to the nature of the compounds of the distillation fractions eluted in the chromatography column for simulated distillation. This valve control is generally performed by means of a computer program. Valves V1 to V4 are connected to one another by lines 103, 104 and 105. The nature of these compounds, i.e. the distillation or the boiling point range corresponding to these compounds, is determined by real-time analysis at way 13 of a katharometric detector 14.

In the device shown in FIG. 1, valves V1 and V2 are designed to connect up chromatography column 11 to way 21 of detector 14, which allows carrying out analysis of the C5− light fraction. Valves V3 and V4 are designed so as to connect up an auxiliary carrier gas supply 71 via a line 72 to dividing injector 43, column 44 and detector 41.

Carrying the C5− light fraction is performed by means of the carrier gas injected with the sample at the level of sample injector 1.

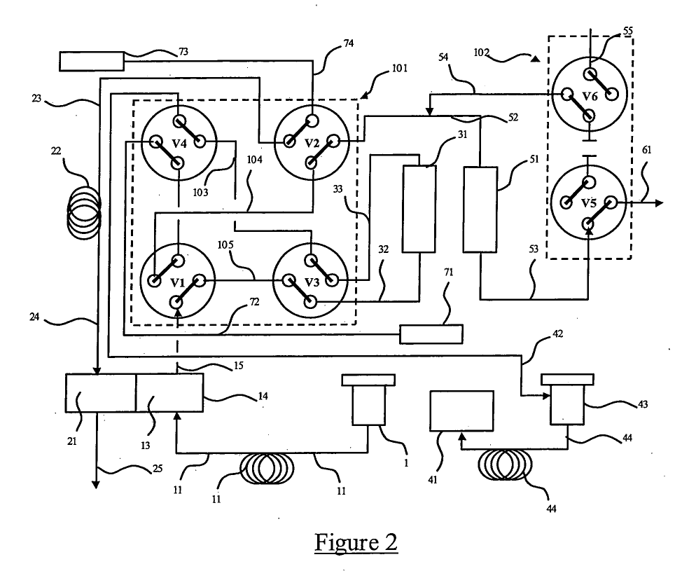

In the device shown in FIG. 2, valves V1, V3 and V4 are designed to connect up chromatography column 11 to C5-C15 fraction retention means 31, the retention means being activated so as to trap the fraction.

Valve V2 is designed to connect up an auxiliary carrier supply 73 to a line 74 so as to provide separation of the lighter fraction in column 22.

Carrying the C5-C15 heavy fraction to retention means 31 is achieved by means of the same carrier gas injected with the sample at the level of sample injector 1.

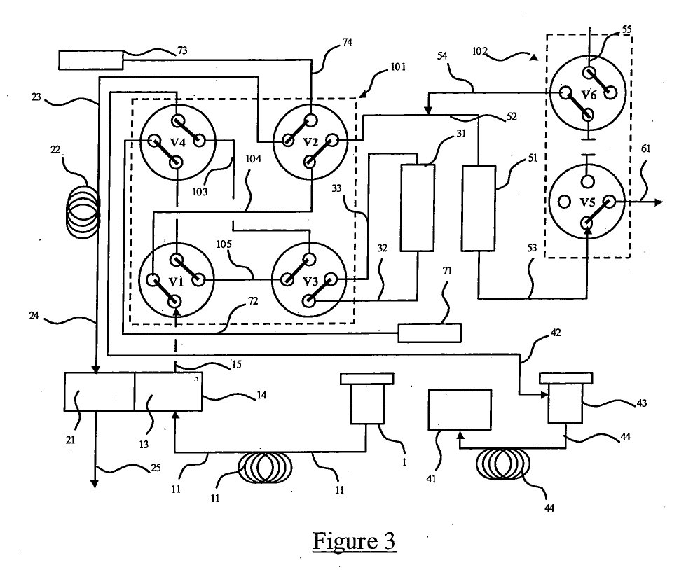

In the device shown in FIG. 3, valves V1, V2 and V5 are designed to connect up chromatography column 11 to C15+ fraction retention means 51, said retention means being activated so as to trap said fraction.

Carrying the C15+ heavy fraction to retention means 51 is achieved by means of the same carrier gas injected with the sample at the level of sample injector 1.

Simultaneously, C5-C15 fraction retention means 31 is isolated by means of valve V3.

Valve V2 also allows connection of auxiliary supply 73 via line 74 to column 22 and detector 21, so as to perform separation and detection of the light fraction constituents.

The layout of connecting means 101 also allows connection of auxiliary carrier gas supply 71 via line 72 and 42 with injector 43, column 44 and detector 41.

Furthermore, valves V1, V2, V3 and V4 are designed so as to:
connect auxiliary carrier gas supply 73 via line 74 to line 23, column 22 and detector 21, and
to connect the main carrier gas supply to injector 1 via valves V1, V3 and V4 with dividing injector 43, column 44 and detector 41.

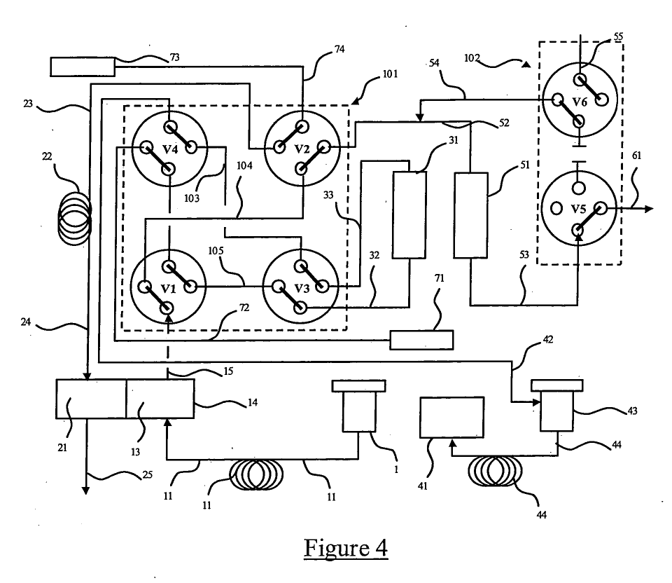

In the device shown in FIG. 4, valves V1, V2 and V5 are still designed to connect up chromatography column 11 to C15+ fraction retention means 51, said fraction being still carried by means of the carrier gas fed at the level of sample injector 1.

Valves V4, V1 and V3 are designed to connect C5-C15 fraction retention means 31 to flame ionization detector (FID) 41, the retention means being activated so as to release said fraction.

Carrying the C5-C15 heavy fraction to FID analyzer 41 is performed by means of auxiliary carrier gas supply 71 through line 72.

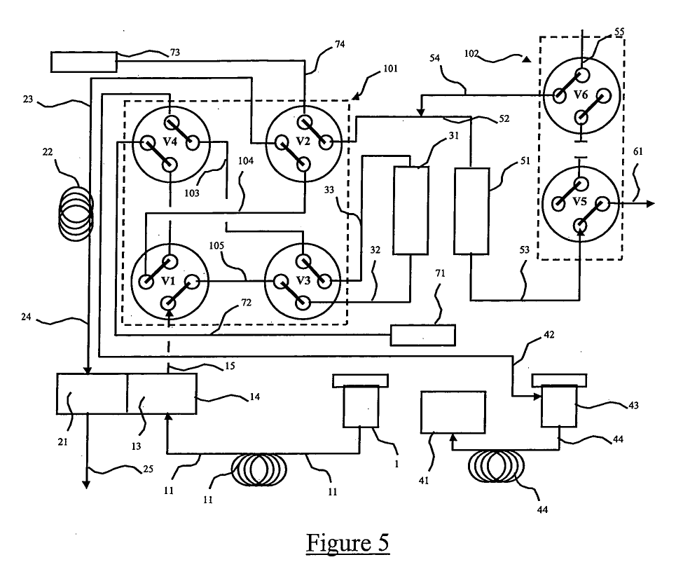

In the device shown in FIG. 5, valves V6, V2 and V5 are designed so as to connect up retention means 51 to line 54 and line 52, said retention means containing the trapped C15+ fraction. Valve V6 allows introduction of the liquid carrier fluid via a supply line 55 carrying the C15+ fraction towards lines 53 and 61, by means of valve V6.

1. An integrated analysis method for characterization of a hydrocarbon sample in distillation fractions, comprising:
a) carrying out a simulated distillation in at least one gas chromatography column so as to separate the sample into a light fraction and at least one heavy fraction;
b) analyzing the light fraction by connecting the gas chromatography column of step a) to an analyzing means suited for analysis of the light fraction and by carrying said fraction into the analysis means;
c) collecting at least one heavy fraction after separation, by connecting the gas chromatography column of step a) to a retention means and by carrying said fraction into said retention means; and
d) analyzing at least one heavy fraction by connecting a retention means to an analysis means suited for analysis of the heavy fraction and by carrying the fraction into the analysis means.

2. A method as claimed in claim 1, wherein the light fraction comprises at least 90% by weight of compounds having 1 to 5 carbon atoms.

3. A method as claimed in claims 1, wherein the or each heavy fraction comprises at least 90% by weight of hydrocarbons boiling above 35° C., preferably above 40° C.

4. A method as claimed in claim 1, wherein, prior to analysis of the light fraction, the light fraction is sent to a chromatography column allowing resolution of the separation of the constituents of said light fraction to be improved.

5. A method as claimed in claim 1, wherein carrying the or each heavy fraction between the retention means and the analysis means comprises a step of desorption of the fraction contained in the retention means, followed by flushing by means of a liquid or gaseous carrier fluid between the retention means and the analysis means.

6. A method as claimed in claim 1, wherein carrying the or each heavy fraction between the retention means and the analysis means comprises isolating the retention means, a desorption by heating the retention means, and flushing using a liquid or gaseous carrier fluid between the retention means and the corresponding analysis means.

7. A method as claimed in claim 1, wherein:
during step a), a light fraction, a first heavy fraction and a second fraction heavier than the first heavy fraction are separated by simulated distillation,
during step c), the first and the second heavy fractions are collected successively, after each separation of the fractions, by connecting the gas chromatography column to respectively a first and a second retention means and by carrying said heavy fractions into their respective retention means; and
during step d), the first and the second heavy fractions are analyzing in detail by connecting the first and second retention means to respectively a flame ionization detector FID and a combined liquid and gas chromatography set, and by carrying the first and second heavy fractions into respectively the flame ionization detector FID and the combined liquid and gas chromatography set.

8. A method as claimed in claim 7, wherein the first heavy fraction comprises 90% by weight of compounds having between 5 and 15 carbon atoms.

9. A method as claimed in claim 7, wherein the second heavy fraction comprises 90% by weight of compounds having more than 15 carbon atoms.

10. An integrated analysis device for characterization of a hydrocarbon sample in distillation fractions, comprising:
a sample injection means for injecting the sample;
a gas chromatography column laid out so as to perform, by simulated distillation, separation of the sample into a light fraction and at least one heavy fraction;
an analysis means suited for analysis of the light fraction;
at least one retention means for collecting the or each heavy fraction after separation;
at least one analysis means suited for analysis of the or each heavy fraction;
connection means for connecting the injection means, the chromatography column, the analysis means suited for analysis of the light fraction, the retention means and the analysis means suited for analysis of each heavy fraction; and
means for carrying the light fraction and the heavy fractions between the chromatography column, the retention means and the analysis means.

11. A device as claimed in claim 10, wherein the gas chromatography column for simulated distillation is equipped with a katharometric detector for real-time determination of the nature of the fraction discharged from the column.

12. A device as claimed in claim 11, wherein the katharometric detector is mounted so as to control the connection means according to a nature of the fraction discharged from the column.

13. A method as claimed in claim 2, wherein the or each heavy fraction comprises at least 90% by weight of hydrocarbons boiling above 35° C., preferably above 40° C.

14. A method as claimed in claim 2, wherein, prior to analysis of the light fraction, the light fraction is sent to a chromatography column allowing resolution of the separation of the constituents of said light fraction to be improved

15. A method as claimed in claim 3, wherein, prior to analysis of the light fraction, the light fraction is sent to a chromatography column allowing resolution of the separation of the constituents of said light fraction to be improved

16. A method as claimed in claim 13, wherein, prior to analysis of the light fraction, the light fraction is sent to a chromatography column allowing resolution of the separation of the constituents of said light fraction to be improved

17. A method as claimed in claim 2, wherein carrying the or each heavy fraction between the retention means and the analyzing means comprises a step of desorption of the fraction contained in the retention means, followed by flushing by means of a liquid or gaseous carrier fluid between the retention means and the analyzing means.

18. A method as claimed in claim 3, wherein carrying the or each heavy fraction between the retention means and the analyzing means comprises a step of desorption of the fraction contained in the retention means, followed by flushing by means of a liquid or gaseous carrier fluid between the retention means and the analyzing means.

19. A method as claimed in claim 4, wherein carrying the or each heavy fraction between the retention means and the analyzing means comprises a step of desorption of the fraction contained in the retention means, followed by flushing by means of a liquid or gaseous carrier fluid between the retention means and the analyzing means.

20. A method as claimed in claim 13, wherein carrying the or each heavy fraction between the retention means and the analyzing means comprises a step of desorption of the fraction contained in the retention means, followed by flushing by means of a liquid or gaseous carrier fluid between the retention means and the analyzing means.

21. A method as claimed in claim 14, wherein carrying the or each heavy fraction between the retention means and the analyzing means comprises a step of desorption of the fraction contained in the retention means, followed by flushing by means of a liquid or gaseous carrier fluid between the retention means and the analyzing means.

22. A method as claimed in claim 15, wherein carrying the or each heavy fraction between the retention means and the analyzing means comprises a step of desorption of the fraction contained in the retention means, followed by flushing by means of a liquid or gaseous carrier fluid between the retention means and the analyzing means.

23. A method as claimed in claim 16, wherein carrying the or each heavy fraction between the retention means and the analyzing means comprises a step of desorption of the fraction contained in the retention means, followed by flushing by means of a liquid or gaseous carrier fluid between the retention means and the analyzing means.

24. A method as claimed in claim 2, wherein carrying the or each heavy fraction between the retention means and the analyzing means comprises isolating the retention means, a desorption by heating the retention means, and flushing using a liquid or gaseous carrier fluid between the retention means and the corresponding analyzing means.

25. A method as claimed in claim 3, wherein carrying the or each heavy fraction between the retention means and the analyzing means comprises isolating the retention means, a desorption by heating the retention means, and flushing using a liquid or gaseous carrier fluid between the retention means and the corresponding analyzing means.

26. A method as claimed in claim 4, wherein carrying the or each heavy fraction between the retention means and the analyzing means comprises isolating the retention means, a desorption by heating the retention means, and flushing using a liquid or gaseous carrier fluid between the retention means and the corresponding analyzing means.

27. A method as claimed in claim 5, wherein carrying the or each heavy fraction between the retention means and the analyzing means comprises isolating the retention means, a desorption by heating the retention means, and flushing using a liquid or gaseous carrier fluid between the retention means and the corresponding analyzing means.
